(19) United States
(12) Patent Application Publication
(10) Pub. No.: US 2025/0197172 A1
(43) Pub. Date: Jun. 19, 2025

(54) LIFTING GEAR AND METHOD FOR STARTING UP THE LIFTING MECHANISM OF SUCH A LIFTING GEAR

(71) Applicant: LIEBHERR-WERK BIBERACH GMBH, Biberach an der Riss (DE)

(72) Inventors: Tobias Englert, Laupheim (DE); Florian Wiest, Biberach (DE); Matthias Thomas, Stuttgart (DE); Oliver Sawodny, Stuttgart (DE)

(21) Appl. No.: 18/846,378

(22) PCT Filed: Mar. 16, 2023
(86) PCT No.: PCT/EP2023/056731

§ 371 Date: Sep. 12, 2024

(30) Foreign Application Priority Data
Mar. 18, 2022 (DE) 10 2022 106 450.6

(51) Int. Cl. B66C 13/48; B66C 13/06; B66C 13/10; B66C 13/16; B66C 23/16

(52) U.S. Cl. CPC B66C 13/48; B66C 13/063; B66C 13/105; B66C 13/16; B66C 23/16

(57) ABSTRACT

A lifting gear such as a crane having a lifting mechanism for lifting a load, a lifting mechanism drive for driving the lifting gear and a control device for controlling the lifting mechanism drive, as well as a method for starting up the lifting mechanism of such a lifting gear for gentle lifting of the load. In an initial phase for initial tensioning of the lifting means, the tightening torque of the lifting mechanism drive is automatically limited by the control device to an initial maximum torque that is only slightly greater than a load-free lifting resistance torque of the lifting mechanism, and then in a further phase for further tightening, the maximum torque increases in a load-induced manner and/or a rate of change of the drive speed of the lifting mechanism drive is limited to a maximum tightening acceleration.

### CROSS-REFERENCE TO RELATED APPLICATIONS

This application is a National Stage of International Application No. PCT/EP2023/056731 filed 16 Mar. 2023, which claims benefit under 35 USC § 365 of DE Application No. 10 2022 106 450.6 filed 18 Mar. 2022, each of which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a lifting gear, for example in the form of a crane such as a tower crane, with a lifting mechanism for lifting a load, a lifting mechanism drive for driving the lifting mechanism and a control device for controlling the lifting mechanism drive. The invention also relates to a method for starting up a lifting mechanism for lifting a load, in which a lifting mechanism drive is operated with initially reduced tightening torque for tensioning a lifting means such as a hoist cable or hoist belt and then with higher tightening torque for continuing the tightening process. The invention also relates to a method for braking such a lifting mechanism to stop the load.

### 2. Description of Related Art

When lifting a load, the crane or hoist operator must proceed carefully and cautiously in order to avoid vibrations in the hoist structure and the associated uncontrolled movements of the load. Particularly with long, slender crane structures such as a tower crane or a telescopic jib crane with long, slender tower and/or jib structures, considerable bending movements of the crane structure occur when loads are picked up, which can resonate elastically during jerky tightening movements and cause the picked-up load to swing uncontrollably. Also during the dropping-off the load there can occur vibrations in the crane structure due to a jerky releasing of the load. The associated problem of pendulum movements of the load picked up is further exacerbated if the load is picked up via a hoist rope running off the jib at a large lowering depth, as a hoist rope that is lowered a corresponding distance can perform considerable pendulum movements.

With heavier loads in particular, such vibrations and pendulum movements can lead to a heavy load on the steel structure, which can endanger nearby persons and objects and in any case extend the lifting time, as an existing vibration of the lifting gear or crane structure and an associated pendulum movement of the load hook should first subside before moving on. Depending on the load, jerky lifting or dropping-off can also lead to damage to the load itself.

When lifting loads, the previously untensioned lifting gear is typically first tensioned before the lifting cable force is then increased until the load increases from the ground. Such lifting gear can be, for example, lifting straps or chains or ropes that connect the load to the load hook, or also untensioned lifting bags for lifting bulk goods such as sand, which initially run slack between the load hook and the load and must first be tensioned before any lifting force is exerted on the load.

If the slings are tensioned and then the hoist rope force is increased, the compliant hoist structure is pre-tensioned during the increase in hoist rope force, similar to a mechanical spring. In the case of a tower crane, the jib can bend and/or the jib guying can elongate elastically and/or the tower can bend, resulting in an overall pitching movement of the jib. If the lifting mechanism drive is activated at too high a speed and the crane structure is abruptly tensioned as a result, the crane structure may vibrate strongly.

Experienced crane operators usually counteract this problem by gentle operation of the lifting mechanism drives. In this case, the crane operator initially tensions the hoist cable and the lifting gear by predetermining a correspondingly slow hoist speed via the master switch until the crane operator feels the tension in the crane structure, so to speak. The crane operator then increases the rope force by setting the hoist speed again until the load slowly begins to hover, which requires experience, dexterity and a good estimation of the load mass as the tension in the hoist cable increases. Experienced machine operators find this tiring, while inexperienced machine operators find it difficult or impossible to increase heavier loads without swinging.

In order to counter similar vibration problems when starting up the lifting mechanism drive from a braked position of the lifting mechanism, it is known that the control system of the lifting mechanism drive intervenes to help when starting up. For example, WO 2018/145806 A1 and EP 30 72 845 A1 propose crane controllers that gently increase the motor torque of the lifting mechanism drive when the holding brake of the lifting mechanism is uncoupled. However, starting up from a braked hoist position is not really comparable to lifting a load that has been placed on the ground or positioned elsewhere on a support, as in a braked hoist position the lifting gear between the load hook and the load is already at full tension and the crane structure is also already pretensioned.

The present invention is based on the task of creating an improved lifting gear of said type, an improved method for starting up a lifting mechanism for lifting a load and an improved method for braking/stopping a lifting mechanism for dropping-off a load, which avoid the disadvantages of the prior art and further develop the latter in an advantageous manner. In particular, a gentle, careful and safe lifting and setting down of a load without vibrations in the crane structure or major pendulum movements of the load-bearing means is to be made possible without any special dexterity on the part of the machine operator.

### BRIEF SUMMARY OF THE INVENTION

According to the invention, the task is solved by a method for starting up a lifting mechanism for lifting a load, in which a lifting mechanism drive is operated with an initially reduced tightening torque for tensioning a lifting means and then with a higher tightening torque for continuing the tightening process, characterized in that, in an initial phase for initial tensioning of the lifting means, the tightening torque of the lifting mechanism drive is automatically limited by a control device to an initial maximum torque (Mₘₐₓ) which is greater than a load-free lifting resistance torque due to inherent resistances such as dead weight, inertia of the lifting mechanism, but less than a load lifting torque required for lifting the load, and in a further phase, when the load acting on the lifting mechanism increases due to the tensioning lifting means and/or a drive speed of the lifting mechanism drive decreases, for further tightening said maximum torque (Mₘₐₓ) is increased and/or the rate of change of the speed of the lifting mechanism drive is limited to a maximum tightening acceleration.

According to the invention, the task is also solved by a method for braking a lifting mechanism for setting down a load on the ground or a drop-off surface, in which a lifting mechanism drive is operated with an initially higher braking torque for initially contacting the load with the drop-off surface and/or initially releasing a lifting means and for continuing the release with a lower braking torque, characterized in that, in an initial phase for initially contacting the drop-off surface and/or initially releasing the lifting means, the braking torque of the lifting mechanism drive is automatically limited by a control device to an initial minimum torque, which is smaller than a load-holding torque required to hold the load, but is greater than a load-free lowering resistance torque due to inherent resistances such as friction and/or inertia of the lifting mechanism, and in a further phase, when a load acting on the lifting mechanism decreases as a result of releasing the lifting means and/or a drive speed of the lifting mechanism drive decreases, for further releasing the minimum torque is reduced and/or the rate of change of the drive speed of the lifting mechanism drive is limited to a minimum deceleration acceleration.

According to the invention, the task is also solved by a lifting gear, in particular a crane such as a tower crane, with a lifting mechanism comprising a lifting means for lifting a load, a lifting mechanism drive for actuating the lifting mechanism and a control device for controlling the lifting mechanism drive, wherein the control device has a starting control stage for starting up the lifting mechanism drive with an initially reduced tightening torque for tensioning the lifting means and for continuing the tightening with a then higher tightening torque, characterized in that the starting control stage of the control device is configured to automatically limit the tightening torque of the lifting mechanism drive to an initial maximum torque (Mₘₐₓ) in an initial phase for initial tensioning of the lifting means, which is greater than a load-free lifting resistance torque due to inherent resistances such as dead weight, friction and/or inertia of the lifting mechanism, but less than a load lifting torque required for lifting the load, and in a further phase, when the load acting on the lifting mechanism increases due to the tensioning of the lifting means and/or a drive speed of the lifting mechanism drive decreases, to increase the maximum torque (Mₘₐₓ) and/or to limit the rate of change of the drive speed of the lifting mechanism drive to a maximum tightening acceleration for further tightening.

It is therefore proposed to automatically limit the tightening torque that can be provided by the lifting mechanism drive when starting up the lifting mechanism, irrespective of any stronger torque and/or speed requirement of the machine operator, or to limit a rate of change of the lifting mechanism drive speed in order to automatically achieve a gentle, gentle and safe lifting of the load. In this case, in particular, the load acting on the lifting mechanism is also taken into account and the maximum torque to which the tightening torque of the lifting mechanism drive is limited is adjusted to the load acting on the lifting mechanism.

According to one aspect of the present invention, it is provided that in an initial phase for initial tensioning of the lifting means, the tightening torque of the lifting mechanism drive is automatically limited by the control device to an initial maximum torque which is greater than a load-free lifting resistance torque due to inherent resistances such as the dead weight of the lifting means, friction and/or inertia of the lifting mechanism, but on the other hand is smaller, in particular also much smaller, than a load lifting torque required for lifting the load, and then, in a further phase, when the load on the lifting mechanism increases due to the tensioning lifting means from the load to be picked up and/or a drive speed of the lifting mechanism drive decreases, the maximum torque is increased for further tightening and/or a rate of change of the drive speed of the lifting mechanism drive is limited to a maximum tightening acceleration.

In this case, the initial maximum torque can be determined by the control device in particular in such a way that the still load-free lifting mechanism, more specifically the lifting mechanism not yet loaded by the external load to be lifted, can move just enough to be able to tension the lifting means, such as the slinging means between the load hook and the load. In other words, the initial maximum torque for the initial phase of starting up the lifting mechanism can be automatically lowered by the control device to such an extent that a lifting mechanism movement of the empty load hook or load-bearing means is just possible at an acceptable speed or the initial maximum torque is just sufficient to overcome the load-free lifting resistance torque or inherent resistance torque of the lifting mechanism. The latter, i.e., the load-free lifting resistance torque, is essentially composed of a frictional torque, which is caused by frictional resistance of the lifting mechanism and the lifting mechanism drive and the load means, for example by deflection of the hoist cable on deflection cylinders, as well as a moment of inertia, which is essentially caused by the dead weight of the lifting mechanism or the lifting mechanism parts to be lifted when the lifting means are still slack, and a moment of inertia, which is caused by the acceleration of the lifting mechanism parts to be moved.

For example, the initial maximum torque, which forms a limit value for the tightening torque of the lifting mechanism drive, can be set to a value in the range of 105% to 150% of the load-free lifting resistance torque and/or can be set by the control device to a value in the range of less than 50% or less than 25% or less than 10% of the load-free lifting resistance torque required to lift the load.

If the slings are tensioned when the lifting mechanism drive is initially started up and the tension in the hoist cable or in the lifting mechanism also increases as a result, the torque requirement of the lifting mechanism drive increases due to the weight of the load to be picked up in order to continue the movement. If the maximum torque predetermined by the control device were to be maintained at the initial maximum torque value, the tightening movement of the lifting mechanism drive would stop very quickly. To avoid this and to enable gentle tightening of the load, the maximum torque to which the tightening torque of the lifting mechanism drive is limited is slowly increased as the tightening process progresses. This increase in maximum torque can be controlled by the control device in different ways.

In particular, the control device can increase the maximum torque depending on the load acting on the lifting mechanism. If the external load acting on the lifting mechanism increases, the control device increases the maximum torque accordingly. For example, the control device can increase the maximum torque of the lifting mechanism drive in proportion to the successively increasing lifting moment. The control device can successively adjust the increase in the maximum torque, to which the tightening torque of the lifting mechanism drive is limited, to the increase in the lifting moment, so that a gentle further tensioning of the lifting means or the entire lifting mechanism occurs.

For example, the lifting gear can have a load-determining device for determining the external load acting on the lifting mechanism, wherein such a load-determining device can, for example, have a load sensor on the load hook, which can measure the load suspended by the load hook, wherein, for example, a load measuring lug can measure the cable tension force on the lifting means. Alternatively, or in addition to a load measuring lug on the load hook, a load cell or a measuring lug can also be provided at another point on the hoist cable, for example at a sling end of the hoist cable, which may be attached to the jib of the crane, for example. Alternatively, or additionally, the load suspended by the lifting mechanism and/or its increase due to tightening of the lifting mechanism drive can also be determined by a deformation sensor system, which can measure deformations of the hoist structure, for example jib and/or tower deformations, which occur in response to the suspended load. Alternatively or additionally, tensile forces in a guy wire can be measured by a guy wire sensor system. Alternatively, or additionally, however, the load-determining device can also detect one or more load-indicating parameters of the lifting mechanism drive by sensors, for example a bearing reaction force of a hoisting cable winch and/or a power consumption of the lifting mechanism drive, for example in the form of a current consumption.

Alternatively or additionally, the load-determining device can also comprise a sensor system which can detect a drive torque and a drive speed or rotational speed of the lifting mechanism drive, wherein the load-determining device can determine the load acting on the lifting mechanism from the detected drive torque and the detected drive speed or rotational speed.

The maximum torque to which the tightening torque of the lifting mechanism drive is limited can be automatically adjusted by the control device to the load determined by the load-determining device, in particular to a load signal from one of the load sensors, and an increase in the load signal can follow. Depending on the design of the load-determining device, the load signal may also initially be further processed, for example to determine a lifting moment induced by the load on the drive shaft of the lifting mechanism drive, in order to then adjust the maximum torque to the lifting moment on the motor shaft.

Alternatively, or in addition to adjusting the maximum torque predetermined by the control device to the load acting on the lifting mechanism, the maximum torque can also be increased, for example via a predetermined rate of change of the torque, until a desired lifting mechanism speed and/or lifting mechanism drive speed is reached. Such a successive increase of the maximum torque from the initial maximum torque to the load lifting torque sufficient for lifting the load with a predetermined rate of change is particularly easy to implement and does not require any information about the load acting on the lifting mechanism, but can also achieve a slow tensioning of the lifting mechanism or the lifting structure and thus a gentle lifting of the load, in particular as long as the distance until the tensioning of the lifting means is not too long.

Specifying a determined rate of change for the tightening torque can also be useful if the control device adjusts the maximum torque in the manner noted above to the successively increasing load acting on the lifting mechanism. In particular, the control device can limit a maximum increase in tightening torque and/or specify a maximum rate of change for the maximum torque in order to avoid too rapid increases in the maximum value for the permissible tightening torque.

Alternatively, or in addition to a load-dependent or defined increase in the maximum torque to which the tightening torque of the lifting mechanism drive is limited, an acceleration limitation can also be provided for the tightening process of the lifting mechanism drive. In this case, for example, an initial maximum torque value can nonetheless be predetermined for the initial tensioning of the lifting means for the tightening torque of the lifting mechanism drive in the manner described above, but this value is then not successively increased, in particular depending on the load, but is canceled when the tightening torque of the lifting mechanism drive reaches the predetermined initial maximum torque and/or the drive speed of the lifting mechanism or the lifting mechanism drive drops. of the lifting mechanism drive decreases, which regularly occurs when the initial tensioning of the lifting means or the stop means tensions at a low initial maximum torque.

The lifting of the torque limitation to the predetermined maximum torque value can be achieved, for example, by increasing the maximum torque sharply and quickly, for example by jumping, or by the control device cancelling the specification of the maximum torque limit.

Simultaneously with the lifting of the torque limitation, or substantially simultaneously with it, the control device can preset a predetermined, preferably low rate of change of the lifting mechanism speed in order to prevent the lifting movement from continuing too quickly. Such an acceleration limitation by the control device can be particularly useful if the lifting mechanism is operated in a speed-controlled manner.

In this case, the lifting process is continued with the automatically predetermined permissible acceleration until the load to be picked up is suspended. As soon as the load is suspended, the machine operator can end the lifting process, for example by releasing a previously pressed button or also via a higher-level control system.

To set the load down on the ground or on a drop-off surface, the procedure can be reversed or analogous and the torque can be lowered in a predetermined manner by the control device. In particular, in a first phase for gentle, initial contact with the ground or the contact surface, the tightening and/or braking torque of the lifting mechanism drive can be automatically limited to an initial minimum torque that is less than the braking torque required to lift or hold the load, but still greater, in particular significantly greater than the load-free lowering resistance torque of the lifting mechanism drive. For example, the initial minimum torque can be set to a value in the range of 99% to 80% or 95% to 90% of the braking torque required to hold the load so that the lifting mechanism lowers slowly.

In a further drop-off phase for releasing the lifting mechanism and/or the lifting means and/or the attachment means, the predetermined minimum torque to which the tightening torque is limited can then be successively reduced, in particular when the external load acting on the lifting mechanism decreases, which occurs as soon as part of the weight of the load is supported by contact with the ground or the drop-off surface.

Analogous to the start-up procedure described above, the minimum torque can be lowered in accordance with the decreasing external load on the lifting mechanism, for example in proportion to the decreasing external load.

By reducing the minimum torque depending on the load, the load can be set down gently on the drop-off surface and the lifting mechanism or the total lifting gear is released slowly without being set into vibration, as would be the case if the load were set down suddenly.

As an alternative to speed control, torque control can also be provided for the lifting mechanism drive. In contrast to speed control, in an operating mode that controls the torque of the lifting mechanism drive, the torque of the lifting mechanism drive can be predetermined as a function of an operating element such as a master switch or a joystick. However, the maximum torque that results when the operating element is fully deflected is then varied by the control device depending on the load acting on the lifting mechanism. Advantageously, the speed can be controlled when the control element is in the zero position, for example, and the torque resulting from the deflection can also be converted.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a schematic side view of a lifting gear in the form of a tower crane, wherein the load attached to the load hook of the lifting gear is still set down on the ground and the attachment means are still untensioned.

FIG. 2 is a side view of the lifting gear from FIG. 1, wherein the load is increased from the ground and the lifting gear structure is completely elastically deformed.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As the figures show, the lifting gear 1 can be designed as a crane, for example in the form of a tower crane, wherein the lifting gear 1 can comprise a jib 14 which, in the case of a tower crane, is carried by a tower 15 or, in the case of a telescopic boom crane, can be luffed and hinged to a superstructure.

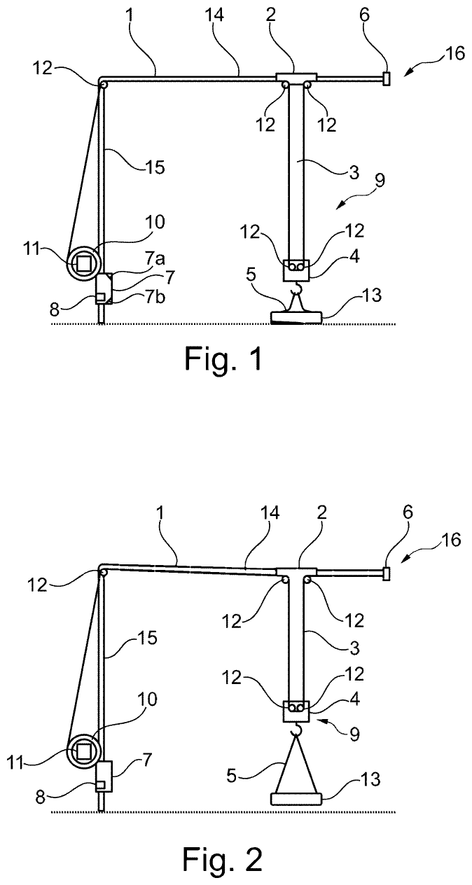

A lifting means 3 descends from the jib 14, in particular in the form of a hoist cable, to which a load-bearing means 4 is hinged, for example in the form of a load hook, wherein a hoist cable can be reeved in one or more times on such a load hook, see FIG. 1.

A trolley 2 can be longitudinally mounted on the jib 14 and can be adjusted by a trolley drive in order to be able to adjust the lifting point or the projection of the lifting means 3 descending from the trolley 2 by moving the trolley 2 along the jib 14.

The lifting means 3 with the load-bearing means 4 hinged thereto forms part of a lifting mechanism 9, which also comprises a lifting winch 10 in order to be able to retract or lower the lifting means 3, wherein a lifting mechanism drive 11 is provided for actuating the lifting winch 10.

The lifting mechanism drive 11 can advantageously comprise an electric motor which can rotationally drive the lifting winch 10 via a gear stage, if provided, and can be controlled by an inverter 8. This enables the control device 7 to easily control the lifting mechanism drive 11, wherein the control device 7 can be designed electronically, for example comprising a microprocessor and a memory in which a program to be processed by the microprocessor and/or operating parameters and/or sensor data can be stored.

In principle, however, it would also be possible to provide a hydraulic lifting mechanism drive that could be controlled by the control device 7 via hydraulic control means. For example, a hydrostat with an adjustable displacement could be provided as a hydraulic lifting mechanism drive, the control lever of which could be controlled by the control device 7 via a suitable actuator.

As the figures show, the lifting mechanism drive 11 and the lifting winch 10 can be arranged on the hoist structure, for example at the base of the tower of a tower crane, wherein the lifting means 3 can be guided from the load-bearing means 4 to the lifting winch 10 via deflection pulleys 12.

In order to determine the load acting on the lifting mechanism 9, a load-determining device 16 is provided, which can be designed to determine a dead load of relevant lifting mechanism parts, for example by the weight of the load-bearing means 4 and/or the weight of the lifting means sections hanging down from the jib 14, and/or can be designed to determine the external lifting mechanism load, which originates from an external load 13 to be lifted, which is suspended or attached to the load-bearing means 4.

As FIGS. 1 and 2 show, the load-determining device 16 can, for example, comprise a load sensor 6 which measures the tensile force in the hoist cable or lifting means 3, wherein such a load sensor 6 can, for example, be provided at one end of the lifting means 3 which is attached, for example to the jib 14, cf. FIG. 1 and FIG. 2. Such a load sensor 6 can, for example, comprise a measuring lug. Alternatively, or in addition to such a cable force sensor, however, the load-determining device 16 can also comprise a load sensor in the area of the load-bearing means 4 in order to determine the load or weight force of the suspended load 13.

Depending on the design of the lifting gear 1, the load-determining device 16 may also comprise other or further sensors, in particular to be able to detect an increase in the load on the lifting mechanism 9 when the load 13 is lifted. For example, if the load 13 can be increased by luffing the jib 14, the load-determining device 16 could comprise a pressure sensor for detecting a hydraulic pressure in a luffing cylinder. Such a luffing cylinder would then be understood as part of the lifting mechanism drive 11, the movement of which is then controlled accordingly by the control device 7, as will be explained.

The procedure for lifting the load 13 can be designed as follows:

Initially, the user fastens the load 13 to the hook or load-bearing means 4 using a sling 5, for example in the form of one or more straps, a chain or a rope. In the next step, the user releases the lifting process by pressing a button or, for example, by deflecting a master switch. This activates a start-up stage 7a of the control device, which automatically controls the start-up process in the manner of a launch control. In the case of a master switch, the set speed until the stop means 5 is tensioned can be selected depending on the deflection of the switch. Alternatively, a start command from a higher-level control system would also be conceivable.

Once the release has been given, the control unit 7 starts the lifting process by specifying a corresponding drive speed. To prevent the load from being lifted too quickly, the torque is limited by the control unit 7, e.g., via the drive inverter 8.

In this case, it makes sense to initially reduce the maximum torque to such an extent that a lifting movement of the empty hook 4 at an acceptable speed is just about possible. This means that the maximum torque Mₘₐₓ is sufficient to overcome the friction M_{R} weight M_{G} and inertia torques M_{T}, i. e.:

$${M}_{max} \approx {M}_{R} + {M}_{G} + {M}_{T} \qquad ( 1 )$$

This can be ensured, for example, by an additional safety factor.

While the frictional torques M_{R} are rather difficult to determine and depend, among other things, on the temperature, the rotational speed and coefficients of friction, so that the frictional torques M_{R} can be estimated by the control device 7 or also neglected, the weight force or the moment of weight M_{G} induced on the lifting mechanism drive 11 is largely determined by the gear ratio c (if a transmission is present), the acceleration due to gravity g and the weight of the load-bearing means my, possibly (as soon as the attachment means 5 are tensioned) by a part of the load mass my and the rope and load hook mass m:

$${M}_{G} = c * ( {m}_{H} + {m}_{L} + {m}_{R} ) * g \qquad ( 2 )$$

By taking into account the inertial force or the associated torque, the maximum torque can be additionally increased during an acceleration process of the load-bearing means 4.

As the tension in the lifting means 3 and in the stop means 5 increases, the torque required to continue the movement increases due to the weight of the load 13. If the maximum torque Mₘₐₓ were kept constant, the (tightening) movement would stop very quickly. However, in order to enable gentle tightening of the load, the maximum torque, which limits the tightening torque of the lifting mechanism drive 11, is slowly increased by the control unit 7 as the load increases in accordance with equation 1. It may also be useful to limit the maximum torque increase.

This results in a slow but continuous increase in the hoist rope tension and thus an increasing bending of the crane structure. If the load on the lifting mechanism 9 does not increase any further, the attached external load 13 is slowly increased, in particular approximately quasi-statically. If the load 13 is free-floating, it can be moved using the standard functions of the control device 7, in particular by actuating corresponding control input means by the machine operator or also automatically by a travel control device.

The load acting on the crane 1 can, for example, be measured via a load sensor 6 of a load-determining device 16 in the drive train or determined from the drive torque and the drive speed by the load-determining device 16.

Alternatively, the maximum torque Mₘₐₓ can, for example, be increased via a defined rate of change of the torque until a desired speed is reached. This approach is particularly easy to implement and does not require any information about the load 13 acting on the lifting gear 1, but also causes the lifting mechanism 9 to be tensioned slowly and thus the load 13 to be lifted gently, in particular as long as the distance until the lifting means 3 is tensioned is not too long.

Alternatively, the following procedure can also be used to slowly increase the rope force and achieve a quasi-static increase in the load:

Initially, the lifting means 3 and the attachment means 5 can be pretensioned with a reduced maximum torque in the same way as described above. As soon as the pre-tensioning force reaches the maximum torque, the movement is stopped (very quickly).

The torque limitation can then be canceled and/or the value can be increased quickly. At least approximately simultaneously, a low rate of change of the lifting mechanism speed can be set via the lifting mechanism 9, preferably in a speed-controlled manner, i.e., an acceleration limitation can be predetermined in order to prevent the tightening movement from continuing too quickly.

The lifting process can then be continued with the defined permissible acceleration until the load is suspended. As soon as the load is suspended, either the operator, e.g., by releasing a previously pressed button, or a higher-level control system can end the lifting process.

The reduced acceleration limitation can then be continuously increased to the nominal maximum acceleration by the control device 7 or its acceleration control stage 7a.

A combination of both approaches with continuous torque increase and limited acceleration is also possible.

Advantageously, the function can be combined with an anti-skew control to form a tightening assistant. In this case, the described lifting process in particular can be synchronized with an automated centering of the trolley 2 over the load 13.

The process can be implemented in the same way when lowering the load 13. A load-dependent minimum torque, which is just below the weight force related to the motor shaft of the lifting mechanism drive 11, is used to slowly drop the load 13. When the load 13 touches down on the ground, the rope 3 is slowly released and damage to the load caused by an impact is avoided.

Another implementation option would be torque control of the hoist motor 11. In contrast to speed control, in this mode the torque of the drive is predetermined as a function of the master switch. The maximum torque that results when the master switch is fully deflected is again varied depending on the load mass. Advantageously, speed control is performed when the master switch is in the zero position and the torque resulting from the deflection is also converted.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A method comprising:
operating a lifting mechanism drive, during an initial phase, with an initially reduced tightening torque for tensioning a lifting means; and
operating the lifting mechanism drive, during a further phase, with a higher tightening torque than the initially reduced tightening torque;
wherein, in the initial phase, the reduced tightening torque of the lifting mechanism drive is automatically limited by a control device to an initial value of a maximum torque (Mₘₐₓ) which is greater than a load-free lifting resistance torque due to inherent resistances of a lifting mechanism for lifting a load, but less than a load lifting torque required for lifting the load; and
wherein, in the further phase, when the load acting on the lifting mechanism increases due to the tensioning of the lifting means and/or a drive speed of the lifting mechanism drive decreases, the value of the maximum torque (Mₘₐₓ) is increased to the higher tightening torque and/or the rate of change of the speed of the lifting mechanism drive is limited to a maximum tightening acceleration.

2. The method according to claim 1, wherein the load acting on the lifting mechanism is determined by a load-determining device.

3. The method according to claim 2, wherein;
in the further phase for tightening:
the maximum torque (Mₘₐₓ) is adjusted by the control device;
the maximum torque (Mm . . . ) is continuously adjusted by the control device; or
the maximum torque (Mₘₐₓ) is increased by the control device; and
further in the further phase for tightening:
the maximum torque (Mₘₐₓ) is adjusted to the load determined by the load-determining device;
the maximum torque (Mₘₐₓ) is continuously adjusted to an increase in the load determined by the load-determining device;
the maximum torque (Mₘₐₓ) is increased following an increase of the load determined by the load determining device;
the maximum torque (Mₘₐₓ) is increased proportionally to the increase of the load determined by the load-determining device; or
the maximum torque (Mₘₐₓ) is continuously increased according to a predetermined rate of change of the torque until a desired drive speed of the lifting mechanism drive is reached.

4. The method according to claim 1, wherein the maximum torque (Mₘₐₓ) is determined by the control device using the following equations:
$${M}_{max} \approx {M}_{R} + {M}_{G} + {M}_{T} \qquad ( 1 )$$
$${M}_{G} = c * ( {m}_{H} + {m}_{L} + {m}_{R} ) * g \qquad ( 2 )$$
wherein;
Mₘₐₓ is the maximum torque acting on the lifting mechanism drive;
M_{R} is the frictional torque acting on the lifting mechanism drive;
M_{G} is the moment of weight acting on the lifting mechanism drive;
M_{T} is the moment of inertia acting on the lifting mechanism drive;
c is a gear ratio;
g is the acceleration due to gravity;
m_{H} is the mass of the load-bearing means;
m_{L} is the mass of the load to be lifted; and
m_{R} is the mass of the lifting means to be lifted.

5. The method according to claim 2, wherein a maximum value for a maximum torque increase is predetermined by the control device.

6. (canceled)

7. The method according to claim 1, wherein, in the further phase, when the higher tightening torque of the lifting mechanism drive reaches the initial value of maximum torque (Mₘₐₓ) and/or a drive speed of the lifting mechanism drive falls below a predetermined value, the control device cancels the initial phase limitation of the reduced tightening torque to the maximum torque (Mₘₐₓ) and/or increases the maximum torque (Mₘₐₓ); and
wherein substantially at the same time as the cancelation of the initial phase limitation of the reduced tightening torque to the maximum torque (Mₘₐₓ) and/or the increasing of the maximum torque (Mₘₐₓ), a predetermined maximum rate of change of the lifting mechanism speed is predetermined as an acceleration limitation.

8. The method according to claim 7, wherein, when or after reaching a substantially constant load on the lifting mechanism, the acceleration limitation is canceled by the control device and/or successively increased to a nominal maximum acceleration.

9. A method for braking a lifting mechanism for setting down a load on the ground or a drop-off surface, in which a lifting mechanism drive is operated with an initially higher braking torque for initially contacting the load with the drop-off surface and/or initially releasing a lifting means and for continuing the release with a lower braking torque, the method comprising:
in a phase for initially contacting the drop-off surface and/or initially releasing the lifting means, the braking torque of the lifting mechanism drive is automatically limited by a control device to an initial minimum torque, which is smaller than a load-holding torque required to hold the load, but is greater than a load-free lowering resistance torque due to inherent resistances of the lifting mechanism; and
in a further phase, when a load acting on the lifting mechanism decreases as a result of releasing the lifting means and/or a drive speed of the lifting mechanism drive decreases, for further releasing the minimum torque is reduced and/or the rate of change of the drive speed of the lifting mechanism drive is limited to a minimum deceleration acceleration.

10. The method according to claim 2, wherein the load acting on the lifting mechanism is determined by a load-determining device; and
wherein the minimum torque is reduced by the control device in the further phase for further releasing the lifting means in accordance with a drop in the load determined by the load-determining device.

11. The method according to claim 2, wherein the lifting mechanism drive is operated by the control device in a speed-controlled manner.

12. The method according to claim 9, wherein the lifting mechanism drive is operated by the control device in a torque-controlled manner.

13. The method according to claim 9, wherein the lifting mechanism drive is controlled by the control device via an inverter, by means of which the tightening and/or braking torque of the lifting mechanism drive is limited.

14. The method according to claim 9, wherein the initial value of maximum torque (Mₘₐₓ) is selected by the control device in the range of 105% to 150% of the load-free lifting resistance torque and/or in the range of less than 50% of the load lifting torque required to lift the load.

15. The method according to claim 2, wherein the initial minimum torque is selected by the control device in the range of 99% to 75% of the braking torque required to lift/hold the load.

16. A lifting gear with a lifting mechanism comprising a lifting means for lifting a load, a lifting mechanism drive for actuating the lifting mechanism and a control device for controlling the lifting mechanism drive, wherein the control device has a starting control stage for starting up the lifting mechanism drive with an initially reduced tightening torque for tensioning the lifting means and for continuing the tightening with a then higher tightening torque, wherein the starting control stage of the control device is configured to automatically limit the tightening torque of the lifting mechanism drive to an initial value of maximum torque (Mₘₐₓ) in a phase for initial tensioning of the lifting means, which is greater than a load-free lifting resistance torque due to inherent resistances of the lifting mechanism, but less than a load lifting torque required for lifting the load, and in a further phase, when the load acting on the lifting mechanism increases due to the tensioning of the lifting means and/or a drive speed of the lifting mechanism drive decreases, to increase the maximum torque (Mₘₐₓ) and/or to limit the rate of change of the drive speed of the lifting mechanism drive to a maximum tightening acceleration for further tightening.

17. The lifting gear according to claim 16, wherein a load-determining device is provided for determining the load acting on the lifting mechanism; and
wherein the starting control stage being configured to increase the maximum torque (Mₘₐₓ) in the further phase for further tightening in accordance with an increase in the load determined by the load-determining device.

18. The lifting gear according to claim 17, wherein the load-determining device has a load sensor for detecting a tensile force in the lifting means and/or a tensile force on the load-bearing means; and
wherein the starting control stage of the control device is configured to increase the maximum torque in accordance with a load signal from the load sensor.

19. A lifting gear with a lifting mechanism comprising a lifting means for lifting a load, a lifting mechanism drive for actuating the lifting mechanism and a control device for controlling the lifting mechanism drive, wherein the control device has a braking control stage for braking the lifting mechanism drive with initially higher braking torque for initially contacting the load with the drop-off surface and/or initially releasing the lifting means and for continuing the braking with then lower braking torque, wherein the braking control stage of the control device is configured to automatically limit the braking torque of the lifting mechanism drive to an initial minimum torque which is smaller than a load lifting torque required for lifting the load, in a phase for initial contacting of the lowering surface and/or initial release of the lifting means, but is greater than a load-free lowering resistance torque due to inherent resistances of the lifting mechanism, and, in a further phase, when a load acting on the lifting mechanism decreases due to release of the lifting means and/or a drive speed of the lifting mechanism drive decreases, to reduce the minimum torque for further releasing and/or to limit the rate of change of the drive speed of the lifting mechanism drive to a minimum deceleration acceleration.

20. The lifting gear according to claim 19, wherein a load-determining device is provided for determining the load acting on the lifting mechanism; and
wherein the deceleration control stage is configured to decrease the minimum torque in the further phase for further tightening in accordance with a decrease in the load determined by the load-determining device.

21. The lifting gear according to claim 20, wherein the load-determining device has a load sensor for detecting a tensile force in the lifting means and/or a tensile force on the load-bearing means; and
wherein the braking control stage of the control device is configured to lower the minimum torque in accordance with a load signal from the load sensor.

22. The method according to claim 1, wherein an inherent resistance of the inherent resistances is selected from a group consisting of dead weight, friction of the lifting mechanism, and inertia of the lifting mechanism.

23. The method according to claim 1, wherein the lifting mechanism drive is operated by the control device in a speed-controlled manner.

24. The method according to claim 1, wherein the lifting mechanism drive is operated by the control device in a torque-controlled manner.

25. The method according to claim 1, wherein the lifting mechanism drive is controlled by the control device via an inverter, by means of which the tightening and/or braking torque of the lifting mechanism drive is limited.

26. The method according to claim 1, wherein the initial value of maximum torque (Mₘₐₓ) is selected by the control device in the range of 105% to 150% of the load-free lifting resistance torque.

27. The method according to claim 1, wherein the initial value of maximum torque (Mₘₐₓ) is selected by the control device in the range of 110% to 125% of the load-free lifting resistance torque.

28. The method according to claim 1, wherein the initial value of maximum torque (Mₘₐₓ) is selected by the control device in the range of less than 50% of the load lifting torque required to lift the load.

29. The method according to claim 1, wherein the initial value of maximum torque (Mₘₐₓ) is selected by the control device in the range of less than 25% of the load lifting torque required to lift the load.

30. The method according to claim 1, wherein the initial value of maximum torque (Mₘₐₓ) is selected by the control device in the range of less than 10% of the load lifting torque required to lift the load.

31. The method according to claim 1, wherein the initial minimum torque is selected by the control device in the range of 99% to 75% of the braking torque required to lift/hold the load.

32. The method according to claim 1, wherein the initial minimum torque is selected by the control device in the range of 95% to 85% of the braking torque required to lift/hold the load.

33. The method according to claim 9, wherein an inherent resistance of the inherent resistances is selected from a group consisting of dead weight, friction of the lifting mechanism, and inertia of the lifting mechanism.

34. The method according to claim 9, wherein the initial value of maximum torque (Mₘₐₓ) is selected by the control device in the range of 110% to 125% of the load-free lifting resistance torque.

35. The method according to claim 9, wherein the initial value of maximum torque (Mₘₐₓ) is selected by the control device in the range of less than 25% of the load lifting torque required to lift the load.

36. The method according to claim 9, wherein the initial value of maximum torque (Mₘₐₓ) is selected by the control device in the range of less than 10% of the load lifting torque required to lift the load.

37. The method according to claim 9, wherein the initial minimum torque is selected by the control device in the range of 95% to 85% of the braking torque required to lift/hold the load.
